(19) United States
(12) Patent Application Publication
(10) Pub. No.: US 2018/0276230 A1
(43) Pub. Date: Sep. 27, 2018

(54) INFORMATION PROCESSING DEVICE, INFORMATION PROCESSING METHOD, AND PROGRAM

(71) Applicant: Sony Corporation, Tokyo (JP)

(72) Inventors: Yue Ouyang, Tokyo (JP); Sachiko Takahashi, Tokyo (JP); Fumiko Shiga, Tokyo (JP); Soichi Fukasawa, Saitama (JP); Tomomasa Watanabe, Kanagawa (JP)

(21) Appl. No.: 15/762,240

(22) PCT Filed: Jun. 17, 2016
(86) PCT No.: PCT/JP2016/068150

§ 371 Date: Mar. 22, 2018

(30) Foreign Application Priority Data
Sep. 29, 2015 (JP) 2015-191909

(51) Int. Cl. G06F 17/30; G06K 9/00; G06F 17/50; A45D 29/18

(52) U.S. Cl. CPC G06F 17/3097; A45D 29/18; G06F 17/5009; G06K 9/00375

(57) ABSTRACT

[Object] To provide an information processing device, information processing method, and program that are capable of improving convenience of nail art creation systems and attaching additional values to provision of nail art designs.

[Solution] The information processing device includes: a decision unit configured to decide a nail art design to be recommended to a user in accordance with information obtained by sensing a finger of the user; and an adjustment unit configured to adjust the decided nail art design.

### TECHNICAL FIELD

The present disclosure relates to information processing devices, information processing methods, and programs.

### BACKGROUND ART

In recent years, gel nail art has become popular. In the gel nail art, gel resin is solidified under ultraviolet light. In addition, in recent years, many people enjoy gel nail art on fingernails and toenails done not only at nail salons but also at home. In view of its time and cost, doing nail art at home is better than going to a nail salon, However, when doing nail art at home, tools and techniques are necessary, and poor nail art may be obtained in comparison with nail art done at a nail salon.

In addition, in recent years, nail art printer devices have become widespread. The nail art printer device prints desired designs on human nails or artificial nails. When using a home-use nail art printer device, it is possible to reduce burden for making a nail salon reservation, save time required to go to the nail salon, and save cost for the nail salon. In addition, it is possible to obtain nail art with designs and quality equivalent to nail art done at nail salons.

With regard to such nail art printing technologies, for example, Patent Literature 1 listed below describes a nail art printer device capable of printing various kinds of designs on respective nail regions, In addition, Patent Literature 2 listed below describes a nail art printer device capable of capturing an image of nail art designs created on nails of another person (such as celebrity or friend) and printing them on nails of a user or on an artificial nail sheet. In addition, Patent Literature 3 listed below describes a nail decoration sheet including an electronic paper layer with a rewritable image.

### CITATION LIST

### Patent Literature

Patent Literature 1: JP 2012-10848A

Patent Literature 2: JP 2012-135587A

Patent Literature 3: JP 2012-20035A

### DISCLOSURE OF INVENTION

### Technical Problem

However, the above described technologies merely print nail art designs selected by a user on his/her nails or on a nail sheet. The above described technologies never mention additional values of nail art creation devices such as recommendation of nail art designs that suits a user or adjustment of a nail art design in accordance with a skin color or sizes of fingers of the user.

Accordingly, the present disclosure proposes an information processing device, information processing method, and program that are capable of improving convenience of nail art creation systems and attaching additional values to provision of nail art designs.

### Solution to Problem

According to the present disclosure, there is provided an information processing device including: a decision unit configured to decide a nail art design to be recommended to a user in accordance with information obtained by sensing a finger of the user; and an adjustment unit configured to adjust the decided nail art design.

According to the present disclosure, there is provided an information processing method including, by a processor: deciding a nail art design to be recommended to a user in accordance with information obtained by sensing a finger of the user; and adjusting the decided nail art design.

According to the present disclosure, there is provided a program causing a computer to function as: a decision unit configured to decide a nail art design to be recommended to a user in accordance with information obtained by sensing a finger of the user; and an adjustment unit configured to adjust the decided nail art design.

### Advantageous Effects of Invention

As described above, according to the present disclosure, it is possible to improve convenience of nail art creation systems and attach additional values to provision of nail art designs.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating an overview of a nail art creation system according to an embodiment of the present disclosure.

FIG. 2 is a diagram illustrating how to use the nail art creation system illustrated in FIG. 1.

FIG. 3 is a diagram illustrating a basic configuration example of a nail art creation system according to an embodiment of the present disclosure.

FIG. 4 is a diagram illustrating a configuration example of a sensor unit included in a nail art creation device according to the embodiment.

FIG. 5 is a block diagram illustrating a functional configuration of a control unit according to the embodiment.

FIG. 6 is a flowchart illustrating a nail art design decision process according to the embodiment.

FIG. 7 is a diagram illustrating acquisition of data to be used for nail art designs according to the embodiment.

FIG. 8 is a diagram illustrating an example of a nail art design selection screen according to the embodiment.

FIG. 9 is a diagram illustrating an example of a nail art design selection screen according to the embodiment.

FIG. 10 is a diagram illustrating an example of a nail art design adjustment screen according to the embodiment.

FIG. 11 is a flowchart illustrating a nail art design recommendation process according to the embodiment.

FIG. 12 is a diagram illustrating an example of a nail art design recommendation screen according to the embodiment.

FIG. 13 illustrates an example of a nail art design color shade adjustment screen according to the embodiment.

FIG. 14 is a flowchart illustrating a nail art creation process according to the embodiment.

FIG. 15 is a flowchart illustrating a complementary nail art design generation process according to the embodiment.

FIG. 16 is a diagram illustrating a configuration example of a nail art creation system according to a modification A of the embodiment.

FIG. 17 is a diagram illustrating how to use the modification A of the embodiment.

FIG. 18 is a diagram illustrating a configuration example of a nail art creation system according to a modification B of the embodiment.

FIG. 19 is a diagram illustrating how to use the modification B of the embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description is given in the following order.
1. Overview of nail art creation system according to embodiment of present disclosure
2. Configuration
2-1. Basic configuration example
2-2. Functional configuration example
3. Operation process
3-1. Nail art design decision process
3-2. Nail art design recommendation process
3-3. Nail art creation process
3-4. Complementary nail art design generation process
4. Modifications
4-1. Modification A
4-2. Modification B
4-3. Another case
5. Conclusion

### <<1. Overview of Nail Art Creation System According to Embodiment of Present Disclosure>>

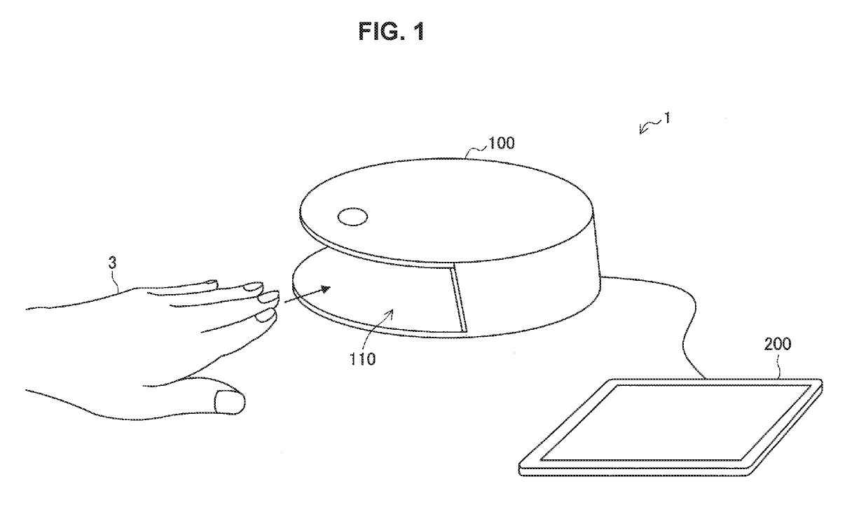

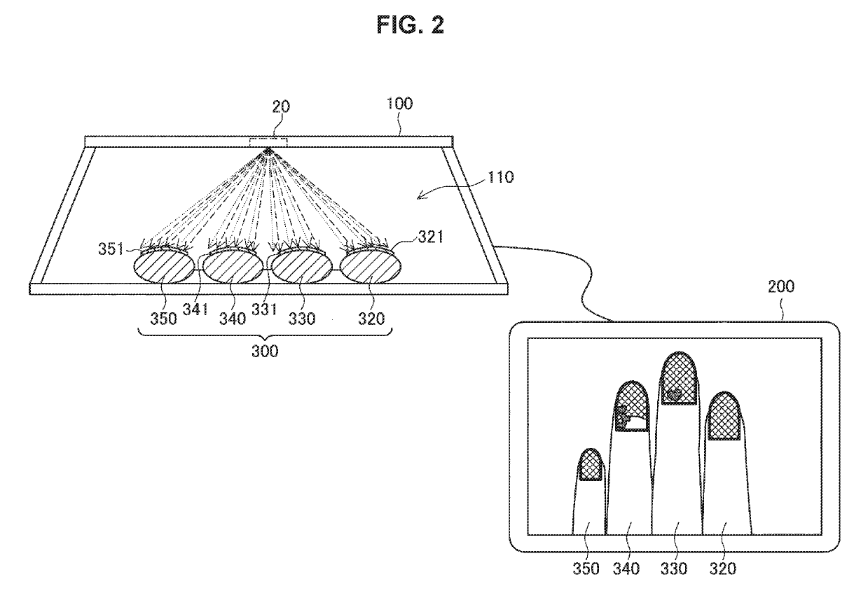

With reference to FIG. 1 and FIG. 2, a nail art creation system according to an embodiment of the present disclosure will be described. FIG. 1 is a diagram illustrating an overview of a nail art creation system 1 according to an embodiment of the present disclosure. As illustrated in FIG. 1. the nail art creation system 1 includes a nail art creation device 100 and a display device 200. The display device 200 may be implemented as an information processing device such as a tablet terminal, a smartphone, a mobile phone terminal, or a PC, for example.

As illustrated in FIG. 1, the nail art creation device 100 has an insertion opening 110, and connects with the display device 200. The nail art creation device 100 and the display device 200 may be connected through short distance wireless communication such as Wi-Fi (registered trademark) or Bluetooth (registered trademark). A user inserts his/her hand 3 into the insertion opening 110 in a state in which nails face upward. In addition, the display device 200 may display an operation screen or the like of the nail art creation device 100.

The nail art creation device 100 is an optical modeling device capable of creating a product (that is, nail art) on nails by solidifying paint applied to nails under laser light. More specifically, it is possible for the nail art, creation device 100 to expose a surface of photosensitive resin applied to a surface (here, nails) of an accumulation target (here, fingers 300), and create products by utilizing alteration of the resin through light radiation.

FIG. 2 is a diagram illustrating how to use the nail art creation system 1 illustrated in FIG. 1. As illustrated in FIG. 2, the nail art creation device 100 uses a movable mirror to optically scan nails 321, 331, 341, 351 of the respective fingers 300 (index finer 320, middle finger 340, ring finger 340, and little finger 350) inserted into the insertion opening 110 through laser light, and solidify paint applied to the respective nails. Note that, in a similar way, a thumb (not illustrated) is also inserted into the insertion opening 110 while the nail faces upward (direction in which the movable mirror 20 is positioned), and scanned though laser light using the movable mirror 20, and thereby paint applied to the nail of the thumb is solidified.

When the optical scanning using the movable mirror 20 finishes, the nail art creation device 100 notifies the user that the photosensitive resin processing is finished. The user checks the notification, and wipes off unsolidified photosensitive resin with alcohol (such as ethanol). In the case where production of products (here, nail art to be created on nails) is not completed, the user applies paint to the nails again, inserts his/her hand into the insertion opening 110 of the nail art creation device 100, and requests the nail art creation device 100 to process photosensitive resin again. When the user inputs an instruction to process the photosensitive resin, the nail art creation device 100 performs the optical scanning using the movable mirror 20 again. In this way, nail art made of products based on a plurality of paints (in other words, nail art with multiple colors) is completed.

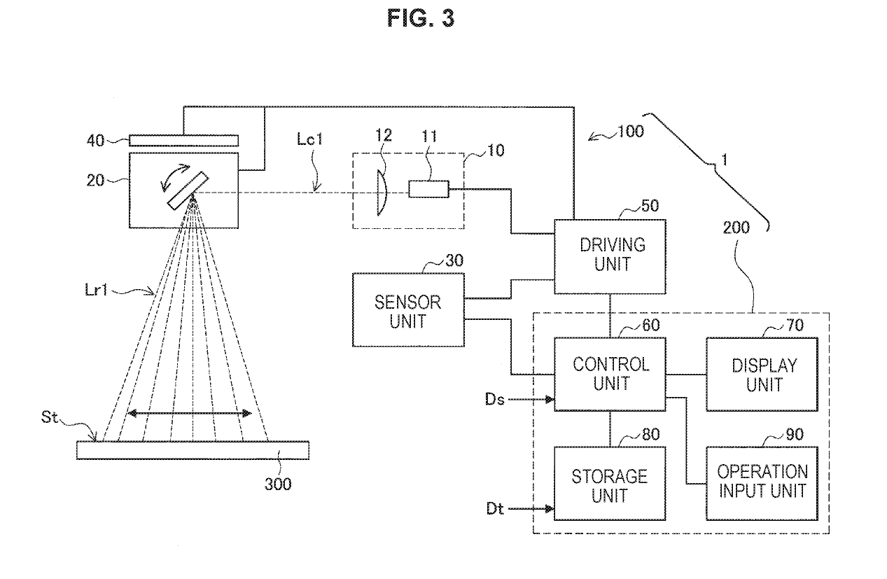

Note that, it is possible to provide a camera (such as imaging unit 40 illustrated in FIG. 3) in the nail art creation device 100. In this case, a captured image of a hand inserted into the insertion opening 110 is displayed on the display device 200. After analyzing the captured image and recognizing positions of nails, it is possible for the display device 200 to display a nail art design image to be recommended to the user such that the nail art design is superimposed on a nail image as illustrated in FIG. 2, and it is possible to simulate creation of nail art. The user can watch a nail art creation simulation screen displayed on the display device 200, and can check whether this nail art design suits his/her fingers. According to the embodiment, it is possible to realize such a nail art simulation function of displaying nail art designs superimposed on nails in a captured image of a hand of a user himself/herself.

### <<2. Configuration>>

### <2-1. Basic Configuration Example>

With reference to FIG. 3, details of a basic configuration example of the nail art creation system 1 including the nail art creation device 100 and the display device 200 will be described.

FIG. 3 is a diagram illustrating the basic configuration example of the nail art creation system 1 according to the embodiment of the present disclosure. As illustrated in FIG. 3, the nail art creation system 1 includes a light source unit 10, the movable mirror 20, a sensor unit 30, an imaging unit 40, a driving unit 50, a control unit 60, a storage unit 80, and a display unit 70. Note that, according to the embodiment, the display device 200 includes the control unit 60, the display unit 70, the storage unit 80, and the operation input unit 90. In addition, the system is configured such that the control unit 60 of the display device 200 controls the nail art creation device 100. However, the embodiment is not limited thereto. The nail art creation device 100 may be integrated with the display device 200. Alternatively, according to the embodiment, it is also possible to implement the display device 200 as a smartphone, a tablet terminal, or the like and configure the display device 200 such that the display device 200 is detachably attached to the nail art creation device 100 (for example, in a slot form). In this case, it is possible to omit the imaging unit 40 from the nail art creation device 100 by capturing an image of a hand inserted into the nail art creation device 100 using a camera of the attached smartphone, a tablet terminal, or the like. In addition, all of the nail art creation system 1 including the nail art creation device 100 and the display device 200, the display device 200 configured to control the nail art creation device 100, and the device in which the nail art creation device 100 is integrated with the display device 200, are equivalent to specific examples of the “information processing device” according to the present disclosure.

The light source unit 10 is capable of outputting collimated light on the basis of a driving signal from the drive unit 50. For example, the light source unit 10 includes a light emitting element 11 configured to output ultraviolet light, and a collimating lens 12 placed on an optical path of the ultraviolet light.

For example, the light emitting element 11 includes one or a plurality of semiconductor lasers, or a one or a plurality of light emitting diodes. The semiconductor laser may be a general laser or a special one such as a second harmonic generation (SHG) laser. The light emitting diode may be a general light emitting diode or a special one such as a superluminescent diode (SLD). For example, the semiconductor laser or the light emitting diode that output ultraviolet light may include a GaInN semiconductor capable of outputting light of a 405 nm band. For example, the semiconductor laser configured to output ultraviolet light is obtained by stacking an n-type AlGaN clad layer, an n-type GaN guide layer, a GaInN multiple quantum well layer, a p-type AlGaN electron blocking layer, a p-type GaN guide layer, a p-type AlGaN clad layer, and a p-type GaN contact later on an n-type GaN substrate in this order. In general, the semiconductor laser has a smaller beam spot diameter than a beam spot diameter of the light emitting diode. Therefore, in the case where one or a plurality of semiconductor lasers are used as the light emitting element 11, it is possible to easily obtain high energy density because the light emitting element 11 has a tiny beam spot diameter.

The collimating lens 12 is capable of making light output from the light emitting element 11 into a parallel light flux (collimated light Lc1) by utilizing refraction through the lens. Note that, instead of the collimating lens 12, the light source unit 10 may include an optical member configured to make light output from the light emitting element 11 into a parallel light flux by utilizing reflection from the mirror.

The movable mirror 20 is placed on the optical path of the collimated light Lc1 output from the light source unit 10. The movable mirror 20 is configured to displace the optical path of the light incident on the movable mirror 20. The movable mirror 20 is configured to reflect the collimated light Lc1 output from the light source unit 10 and displace the movable mirror 20 on the basis of a driving signal from the drive unit 50. Thereby, an optical path of reflected light Lr1 is displaced, and a target surface St (in the embodiment, surfaces of photosensitive resin (paint) applied to the nails of the fingers 300) is scanned through the collimated light Lc1 (reflected light Lc1). For example, the movable mirror 20 may include a microelectromechanical systems (MEMS) mirror, a polygon mirror, or a galvano mirror.

The sensor unit 30 is configured to acquire positional data Ds of a predetermined surface including the target surface St, and output it to the control unit 60. The positional data Ds is a three-dimensional coordinate data of the predetermined surface including the target surface St. The sensor unit 30 may break down the predetermined surface including the target surface St into a plurality of elements and acquire three-dimensional coordinates for the respective broken-down elements. Alternatively, the sensor unit 30 may break down only the target surface St into a plurality of elements and acquire three-dimensional coordinates for the respective broken-down elements.

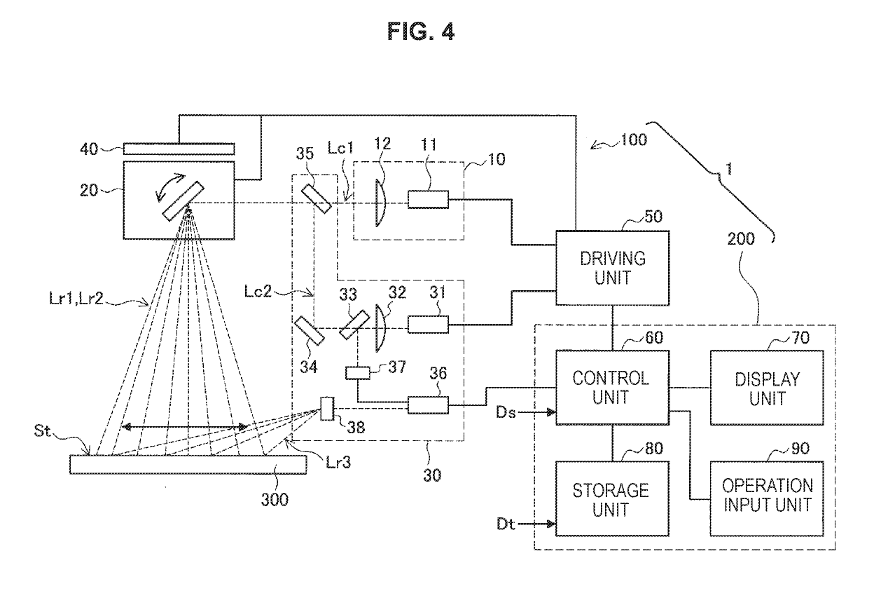

The sensor unit 30 includes a distance sensor. For example, the sensor unit 30 includes a near-infrared sensor using time of flight (TOF). For example, in the TOF, a distance between the movable mirror 20 and the predetermined surface including the target surface St is measured on the basis of a time lag between respective pulse light beams obtained from two light receiving elements. For example, as illustrated in FIG. 4, the sensor unit 30 includes a light emitting element 31 configured to output near-infrared light, a collimating lens 32 placed on an optical path of the near-infrared light, a half mirror 33, a total reflection mirror 34, and a dichroic mirror 35. In addition, for example, as illustrated in FIG. 4, the sensor unit 30 further includes a time lag detection circuit 36 and two light receiving elements that are connected with input terminals of the time lag detection circuit 36.

For example, the light emitting element 31 includes a semiconductor capable of outputting light of an 833 nm band. The collimating lens 32, the half mirror 33, and the total reflection mirror 34, and the dichroic mirror 35 are placed in this order toward a propagation direction of the near-infrared light output from the light emitting element 31. The dichroic mirror 35 is also placed on an optical path of light output from the light emitting element 11. The collimating lens 32 is configured to make near-infrared light output from the light emitting element 31 into a parallel light flux (collimated light Lc2) by utilizing refraction through the lens. The half mirror 33 is configured to transmit a part of the collimated light Lc2 and reflect a part of the collimated light Lc2 toward the light receiving element 37. The total reflection mirror 34 is configured to reflect all light transmitted through the half mirror 33 among the collimated light Lc2. The dichroic mirror 35 is configured to transmit the collimated light Lc1 and reflect the collimated light Lc2 toward the movable mirror 20.

The light receiving element 37 is configured to receive light reflected from the half mirror 33 among the collimated light Lc2. The light receiving element 38 is configured to receive light (reflection light Lr3) reflected from the target surface St among the collimated light Lc2. For example, the light receiving elements 37 and 38 may be photodiodes.

The time lag detection circuit 36 is configured to derive a time lag between respective light beams (pulse light beams) obtained from the two light receiving elements 37 and 38, and measure a distance between the movable mirror 20 and a region including the target surface St on the basis of the derived time lag. The time lag detection circuit 36 is configured to derive the positional data Ds on the basis of the distance between the movable mirror 20 and the region including the target surface St, and output it to the control unit 60.

The imaging unit 40 captures an image of the region including the target surface St. For example, the imaging unit 40 includes a twin-lens camera. The control unit 60 is configured to derive a “distance from the imaging unit 40 to the region including the target surface St” from a stereo image obtained by the imaging unit 40 through triangulation. The control unit 60 is also capable of deriving the positional data Ds on the basis of the distance from the imaging unit 40 to the region including the target surface St. In addition, it is also possible for the control unit 60 to cause the display unit 70 to display an image of the fingers 300 captured by the imaging unit 40. Note that, it is also possible to use a monocular camera to measure a distance (so-called depth) from the imaging unit 40 to the region including the target surface St. For example, when focusing on a foreground surface of the target surface St using the monocular camera and capturing a plurality of images while gradually shortening the focal length, it is possible to measure roughness and curves of a nail serving as the target surface St, and acquire the positional data Ds.

For example, the storage unit 80 is configured to be capable of storing coordinate data Dt. The display unit 70 displays an operation screen of the nail art creation device 100, a nail art simulation screen, a nail art recommendation screen, or the like on the basis of a control signal from the control unit 60. The operation input unit 90 is implemented as a button, a switch, a touchscreen, a keyboard, a mouse, or the like, and receives operation input by a user. The display device 200 including the control unit 60, the display unit 70, the storage unit 80, and the operation input unit 90 is implemented as an electronic device such as a smartphone, for example.

The coordinate data Dt is data representing shapes and sizes of products (the products are created by solidifying paint applied to nails under laser light. In the embodiment, the products are equivalent to nail art) by using a plurality of coordinate data pieces. In addition, color information may be associated with each of the coordinate data pieces in the coordinate data Dt.

The driving unit 50 is configured to drive the light source unit 10, the movable mirror 20, the sensor unit 30, and the imaging unit 40 on the basis of control signals from the control unit 60.

The control unit 60 is configured to control the light source unit 10, the movable mirror 20, the sensor unit 30, and the imaging unit 40 via the driving unit 50. Via the driving unit 50, the control unit 60 displaces the movable minor 20, and the optical path is displaced in accordance with the displacement of the movable mirror 20 such that the target surface St is scanned by the collimated light Lc1 (light reflected from the movable mirror 20 (reflection light Lr1)). In addition, the control unit 60 reads out the coordinate data Dt from the storage unit 80, and then controls light emission of the light source unit 10 on the basis of the coordinate data Dt via the driving unit 50.

The control unit 60 is configured to control light emission of the light source unit 10 on the basis of the positional data Ds and the coordinate data Dt. The control unit 60 is configured to control light emission of the light source unit 10 on the basis of the positional data Ds and the coordinate data Dt that have been acquired before scanning. Specifically, the control unit 60 is configured to correct coordinate data Dt on the basis of positional data Ds acquired before scanning, and control light emission of the light source unit 10 on the basis of coordinate data Dt′ obtained through the correction.

### <2-2. Functional Configuration Example>

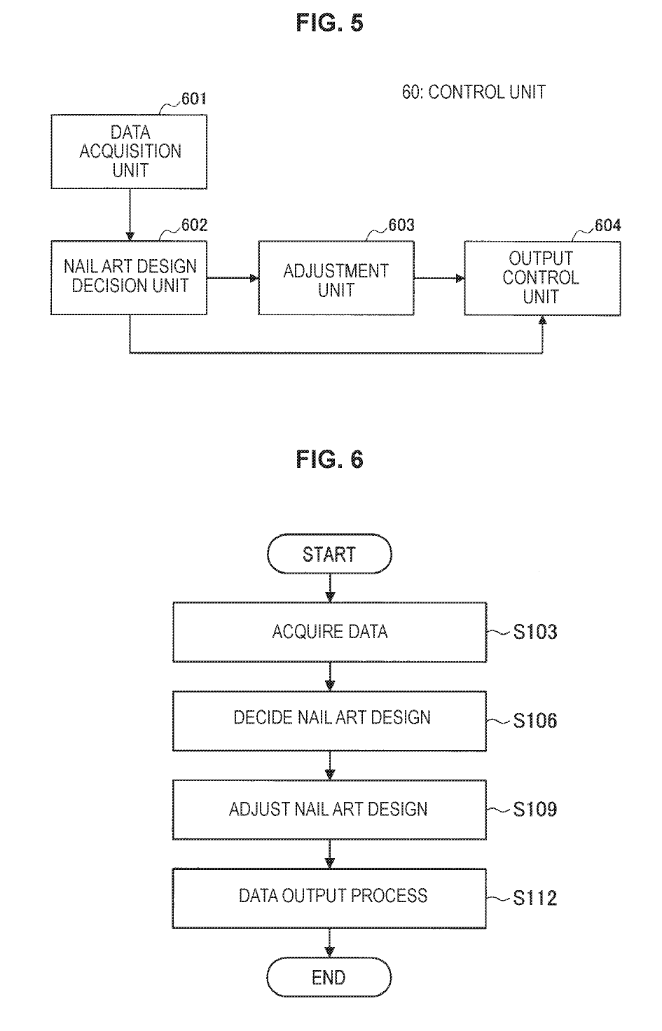

Next, with reference to FIG. 5, a functional configuration of the control unit 60 will be described. FIG. 5 is a block diagram illustrating the functional configuration of the control unit 60 according to the embodiment. As illustrated in FIG. 5, the control unit 60 functions as a data acquisition unit 601, a nail art design decision unit 602, an adjustment unit 603, and an output control unit 604.

The data acquisition unit 601 acquires positional data Ds of the target surface St from the sensor unit 30 of the nail art creation device 100. In addition, it is also possible for the data acquisition unit 601 to acquire image data from an external device and a cloud. The image data is used by the nail art design decision unit 602 (to be described later) to generate nail art designs. In addition, it is also possible for the data acquisition unit 601 to acquire registered nail art design image data from the storage unit 80.

The nail art design decision unit 602 decides nail art designs (including at least a pattern and color) to be presented to a user. More specifically, for example, the nail art design decision unit 602 decides nail art designs that suit a skin color and sizes of nails of a user on the basis of information acquired through sensing of the fingers 300 of the user (such as a captured image). In addition, it is also possible for the nail art design decision unit 602 to decide appropriate nail art designs on the basis of clothing, a hairstyle, a hair color, a job, or a scene (for example, wedding party, a coming of age ceremony, dating, a club, a leisure place such as mountain or sea) of a user. In addition, it is also possible for the nail art design decision unit 602 to decide an appropriate nail art design for a nail with a lost nail art design among respective nails, in accordance with nail art designs of the other nails on the basis of a captured image of the fingers 300 of the user. Note that, it is possible for the nail art design decision unit 602 to generate the nail art designs to be presented to the user on the basis of nail art design image data selected by the user, existing nail art design image data, or the like.

The adjustment unit 603 adjusts the nail art design decided by the nail art design decision unit 602. For example, the adjustment unit 603 adjusts sizes of the nail art designs in accordance with sizes of respective nails of the user on the basis of the captured image of the fingers 300 of the users. In addition, the adjustment unit 603 adjusts color shades of the decided nail art designs in accordance with the skin color of the user extracted from the captured image of the fingers 300 of the user. In addition, it is also possible for the adjustment unit 603 to adjust the sizes and the color shades of the nail art designs in response to user operation.

The output control unit 604 outputs a control signal to the drive unit 50 of the nail art creation device 100 such that products are created by using the nail art designs adjusted by the adjustment unit 603. In addition, it is possible for the output control unit 604 to perform control such that a nail art recommendation screen is generated and the display unit 70 displays the nail art recommendation screen to present the adjusted nail art designs to the user. In this case, it is also possible for the output control unit 604 to present a nail art simulation screen in which image data of the adjusted nail art designs is superimposed on respect nails in the image of the fingers 300 of the user captured by the imaging unit 40. In the case of superimposing the image data of the nail art designs on the nails in the captured image, the output control unit 604 displays the superimposed data in view of roughness and curves of the nails on the basis of depth information of the respective nails (specifically, information regarding roughness and curves of nail surfaces). Therefore, it is possible to prevent a feeling of strangeness about simulation. In addition, it is possible for the output control unit 604 to perform control such that an adjustment screen is generated and the display unit 70 displays the adjustment screen. The adjustment screen is used by the user to adjust the nail art designs decided by the nail art design decision unit 602.

Note that, a server may include at least a part of the functions of the control unit 60. In addition, the server may include the control unit 60 and the storage unit 80. In this case, the display device 200 and/or the nail art creation device connects with the server via a network, receives various kinds of control signals and screen display information from the server, and transmits a captured image acquired by the imaging unit 40 and the positional data Ds and the coordinate data Dt acquired by the sensor unit 30.

### <<3. Operation Process>>

Next, with reference to FIG. 6 to FIG. 15, operation processes of the nail art creation system according to embodiment will be described.

### <3-1. Nail Art Design Decision Process>

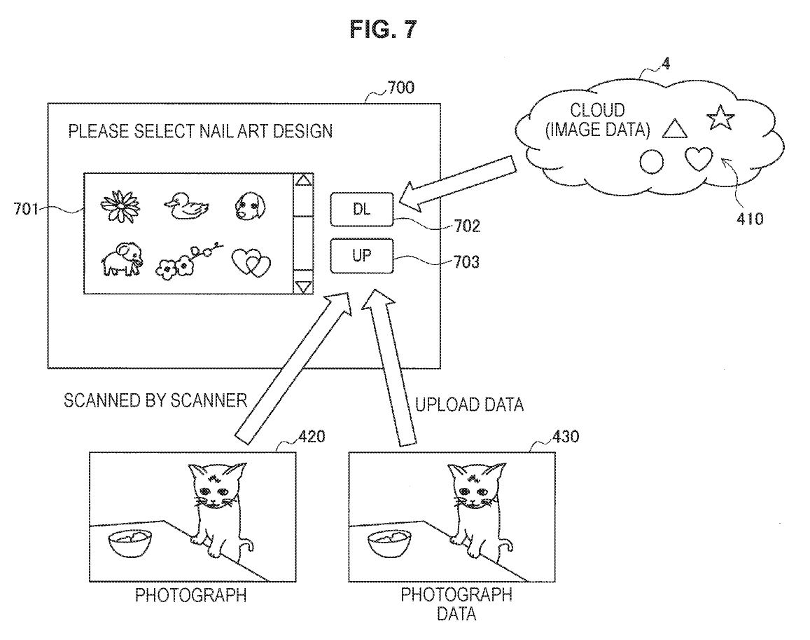

FIG. 6 is a flowchart illustrating a nail art design decision process according to the embodiment. As illustrated in FIG. 6, the data acquisition unit 601 of the control unit 60 first acquires data to be used for a nail art design (Step S103). The data acquisition unit may acquire the data from the storage unit 80, the external device, the server, or the like. In addition, it is also possible for the user to acquire preferred data from the server, the external device, or the like. Here, FIG. 7 is a diagram illustrating acquisition of data to be used for nail art designs.

A screen 700 illustrated in FIG. 7 is a nail art design selection screen displayed on the display unit 70 of the display device 200. In the screen 700, nail art design candidates 701, a download (DL) button 702, and an upload (UP) button 703 are displayed. In the case of acquiring a nail art design 410 from a server on a cloud 4, a user taps the download (DL) button 702, transitions to a DL screen, and performs acquisition operation of data from the server. In addition, in the case of loading an image to be used for a nail art design (hereinafter, also referred to as a nail art design image) into the nail art creation system 1, the user taps the UP button 703, transitions to an UP screen, and performs acquisition operation of data from the external device. Specifically, for example, a photograph 420 or an illustration is loaded via a scanner (not illustrated), the nail art creation system 1 is caused to acquire the scanned data, or the nail art creation system 1 is caused to acquire photograph data 430 stored in a camera, a PC, or the like.

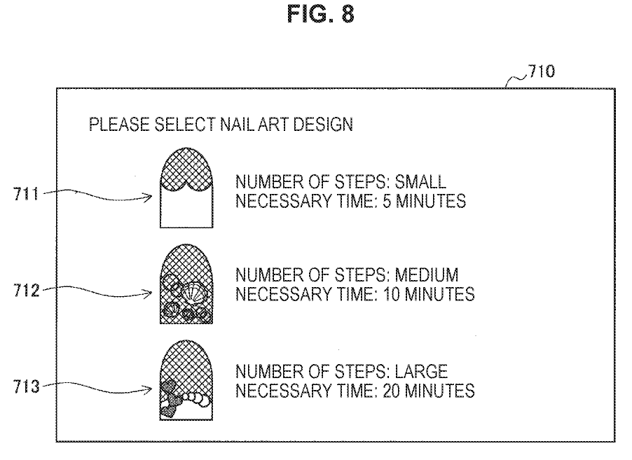

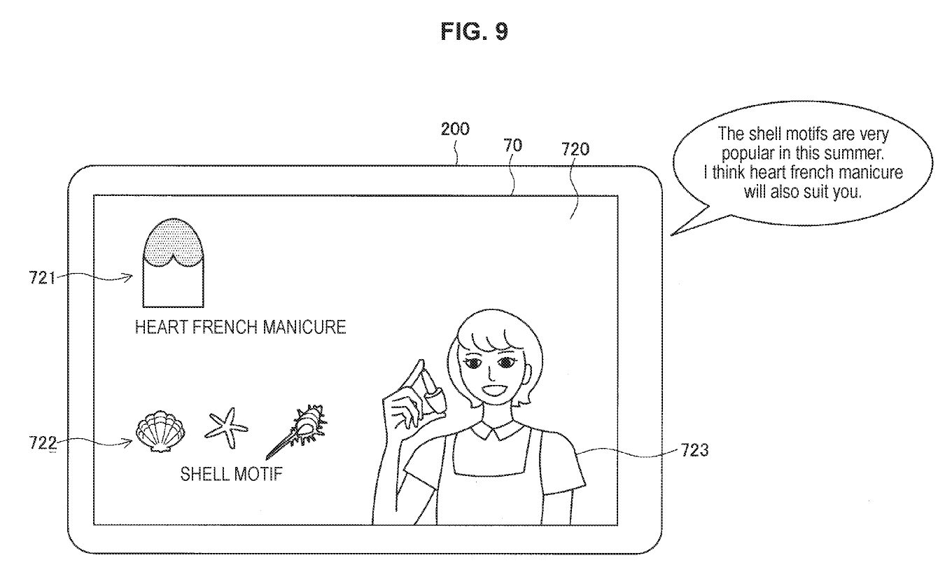

Next, the nail art design decision unit 602 of the control unit 60 decides a nail art design (Step S106). The nail art design may be automatically recommended and decided by a system side as described later, or may be decided in accordance with a selection made by the user. For example, through the screen 700 illustrated in FIG. 7, the user can freely select nail art designs from among the nail art design candidates 701, the nail art designs 410 downloaded from the cloud 4, or from scan data of the photograph 420 uploaded from the external device or the photograph data 430. In addition, in the embodiment, it is also possible to display advice in the selection screen when the user is selecting nail art designs. Next, the following description is given with reference to FIG. 8 and FIG. 9.

FIG. 8 is a diagram illustrating an example of the nail art design selection screen according to the embodiment. In the illustrated example, nail art design candidates 711, 712, 713, the number of steps necessary to make the respective nail art designs (the number of manufacturing processes), and time necessary to make the respective nail art designs (time necessary to finish manufacturing) are displayed in a screen 710. The number of steps (the number of manufacturing processes) includes a step of applying paint on nails of the user, a step of radiating laser light, and a step of eliminating unsolidified parts. In this way, the user can consider necessary burden and time when selecting a nail art design.

FIG. 9 is a diagram illustrating an example of the nail art design selection screen according to the embodiment. In the illustrated example, nail art design candidates 721 and 722 that are recommended by the system side and a character 723 are displayed in a screen 720. The control unit 60 may output voice from a loudspeaker (not illustrated) installed in the display device 200 such that the character 723 who is a nail technician explains the recommended nail art design candidates 721 and 722.

In addition, it is also possible for the nail art creation system according to the embodiment to collect speech from the user via a microphone (not illustrated), analyze the speech, and respond to the recognized speech by voice of the character 723. Therefore, it is possible to cause the user to experience conversation with the nail technician. For example, in the case where the user has given instructions regarding a design, a color, arrangement of items, or the like by voice, a nail art design is generated in accordance with the instructions and displayed on the screen. In addition, the character 723 who is the nail technician is displayed and voice like “how about this one?” is output. Accordingly, the user can order his/her original nail art design while having conversations with the nail technician.

In addition, as illustrated in FIG. 9. it is also possible for the control unit 60 to output information regarding nail art such as trendy nail art designs by voice of the character 723 who is the nail technician. Thereby, it is possible to prevent the user from always selecting similar designs, and it is possible for the user to enjoy change in the designs. In addition, it is possible for the user to find new designs for him/her.

In addition, during creation of nail art (during scanning through laser light or while waiting for a next step), the display unit 70 is caused to display the character 723 who is the nail technician and output information other than the nail art such as fashion information, entertainment information, and news (or various kinds of information appropriate to the user) by voice, and it is possible to provide the user with experience as if he/she has conversations with the nail technician in a nail salon. In addition, the information outputted from the character 723 who is the nail technician is not limited to the various kinds of information described above. Such information may include advertisement information. As described above, it is possible not only to merely create nail art, but also to establish communication with a nail technician like communication in a nail salon. This can provide additional values other than creation of nail art.

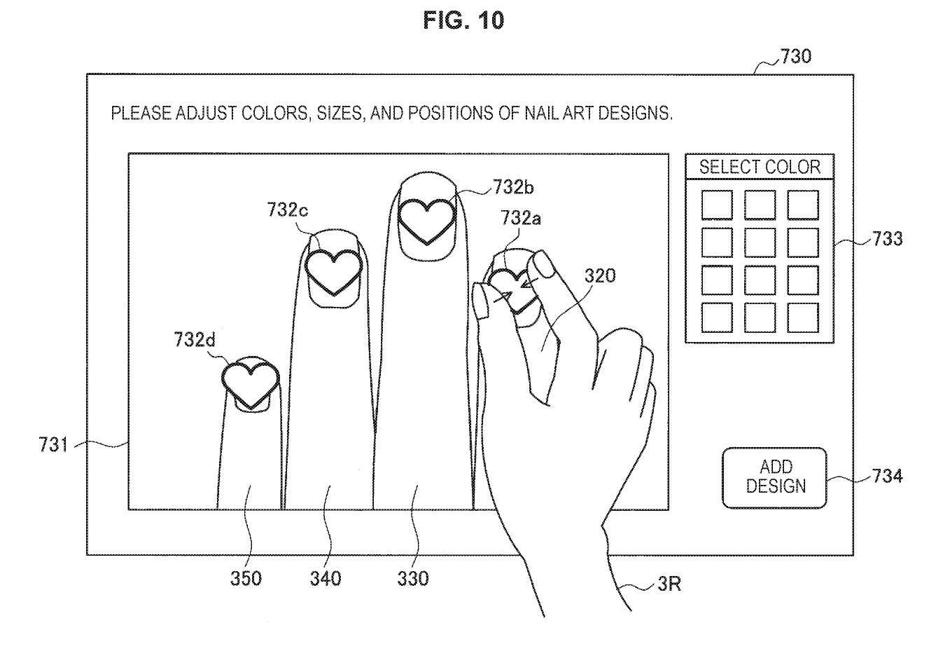

Next, the adjustment unit 603 of the control unit 60 may adjust the nail art design (Step S109). The adjustment unit 603 is capable of adjusting the position and the size of the nail art design. Sizes of nails are different between people or between fingers. Therefore, if the decided nail art design is applied to all the nails in the same way, sometimes its design may be deteriorated. For example, the adjustment unit 603 is capable of automatically adjusting positions and sizes of the nail art designs in accordance with sizes of respective nails on the basis of an image captured by the imaging unit 40. In addition, the adjustment unit 603 is also capable of adjusting the positions and the sizes of the nail art designs in response to user operation. Here, FIG. 10 illustrates an example of a nail art design adjustment screen.

In the example illustrated in FIG. 10, a captured image display screen 731, a nail art design color selection screen 733, and a design addition button 734 are displayed in the screen 730. The captured image display screen 731 displays an image captured by the imaging unit 40. For example, this screen 730 is displayed on the display unit 70 of the display device 200 implemented as a tablet terminal, and user operation performed on the screen 730 is detected through a touchscreen (an example of the operation input unit 90) integrated with the display unit 70. The captured image display screen 731 displays nail art designs 732a to 732d superimposed on an image of respective nails (respective nails of index finger 320, middle finger 330, ring finger 340, and little finger 350). Subsequently, it is possible for the user to enlarge/reduce the sizes of the nail art designs 732a to 732d through pinch-in/pinch-out operation, and to move the positions of the nail art designs 732a to 732d through drag-and-drop operation or flick operation. In this way, the user can freely adjust the nail art designs. Note that, as illustrated in FIG. 10, in the case where the captured image display screen 731 displays a through image in real time, the user adjusts the positions and sizes by his/her right hand 3R while inserting his/her left hand into the insertion opening 110 of the nail art creation device 100.

In addition, it is possible for the user to freely decide colors of a nail art design image through the color selection screen 733. In addition, in the case of adding a nail art design image, it is possible to return to the screen illustrated in FIG. 7 (selection screen) and select a new nail art design image by tapping the design addition button 734.

As described above, the nail art designs are adjusted appropriately.

In addition, as illustrated in FIG. 6, the output control unit 604 of the control unit 60 outputs a control signal for creating nail art to the nail art creation device 100 on the basis of the adjusted nail art designs (Step S112).

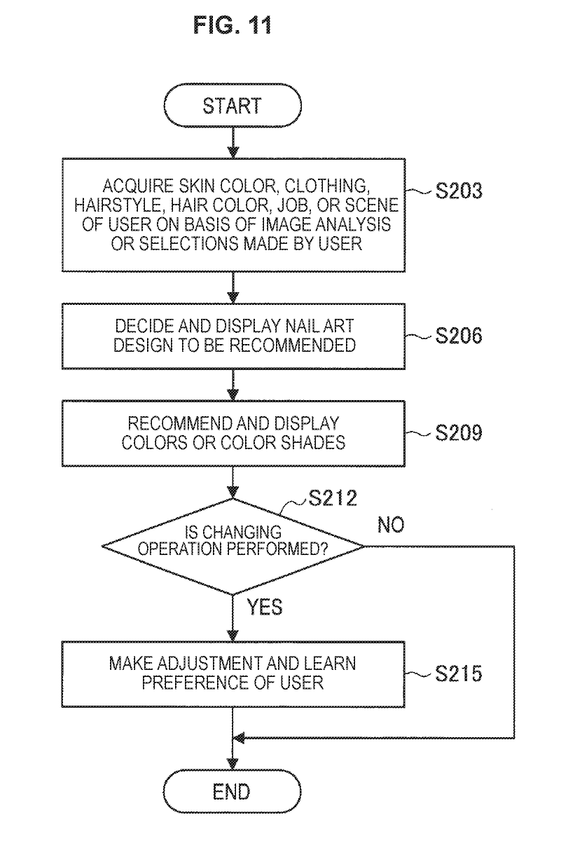

The nail art design decision process according to the embodiment has been described above. As described with reference to FIG. 7 to FIG. 9, basically, the user freely selects nail art designs and adjusts sizes and positions of the nail art designs in the above described process. However, the embodiment is not limited thereto. Sometimes it is difficult for a user to select designs that suit him/her from among various kinds of designs. In addition, it is also difficult for the user to select colors that suit him/her in view of slight difference between similar colors. In view of such circumstances, according to the embodiment, it is possible to recommend appropriate nail art designs in accordance with a skin color, clothing, a hairstyle of a user, Next, detailed description will be provided with reference to FIG. 11 to FIG. 13.

### <3-2. Nail Art Design Recommendation Process>

FIG. 11 is a flowchart illustrating a nail art design recommendation process according to the embodiment. As illustrated in FIG. 11, the data acquisition unit 601 of the control unit 60 first acquires a skin color, an eye color, clothing, a hairstyle, a hair color, a job, or a scene of a user on the basis of image analysis or selections made by the user (Step S203). More specifically, for example, the data acquisition unit 601 is capable of detecting the skin color on the basis of an image of a hand 3 of the user captured by the imaging unit 40, and is capable of detecting the clothing, the hairstyle, or the hair color on the basis of a captured image of a face or a whole body of the user. In addition, the data acquisition unit 601 may acquire an age, a job (sales, reception desk, clerical position, or the like), or a scene (for example, wedding party, a coming of age ceremony, dating, a club, a leisure place such as mountain or sea) of the user input by the user through the operation input unit 90. In addition, the data acquisition unit 601 may acquire a skin color, clothing, a hairstyle, or a hair color of the user that have been input by the user through the operation input unit 90.

Next, the nail art design decision unit 602 of the control unit 60 decides a nail art design to be recommended to the user on the basis of the acquired information of the user, and the output control unit 604 causes the display unit 70 to display the decided nail art design (Step S206). For example, on the basis of the acquired job or scene of the user, the control unit 60 recommends a nail art design popular in a similar job or a similar scene to the user. In addition, it is also possible for the control unit 60 to recommend a nail art design popular among people with a similar hairstyle or clothing to the user, on the basis of the acquired hairstyle or clothing of the user. Alternatively, it is also possible to recommend a nail art design or a nail art design pattern suitable to registered hairstyles or clothing, to nail technicians, fashion stylists, or the like.

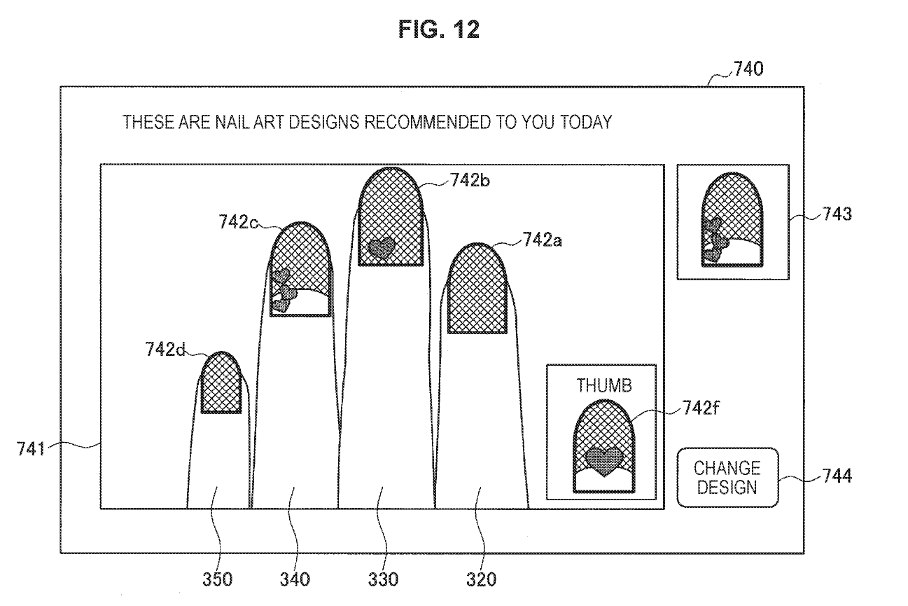

In addition, when the control unit 60 displays nail art designs to be recommended to the user, the displayed content is not limited only to nail art design images. For example, it is also possible to display a nail art design image superimposed on a captured image of a hand of a user. Accordingly, it is possible to prevent the user from feeling that nail art designs actually created on his/her nails are different from nail art designs the user has selected. Here, FIG. 12 illustrates an example of a nail art design recommendation screen according to the embodiment.

In the example illustrated in FIG. 12, a captured image display screen 741, a representative recommendation nail art design image 743, and a design changing button 744 are included in a screen 740. On the basis of an analysis result of a captured image, the output control unit 604 of the control unit 60 adjusts sizes of nail art design images 742a to 742d such that the images match shapes of fingers of the user, states of nail surfaces, and sizes of the nails, and displays the images superimposed on the finger image of the user. In this way, the user can virtually try on nail art by using a display. Note that, such nail art trial fitting can be performed not only in the case of recommending nail art designs but also in the case of nail art designs selected by the user himself/herself.

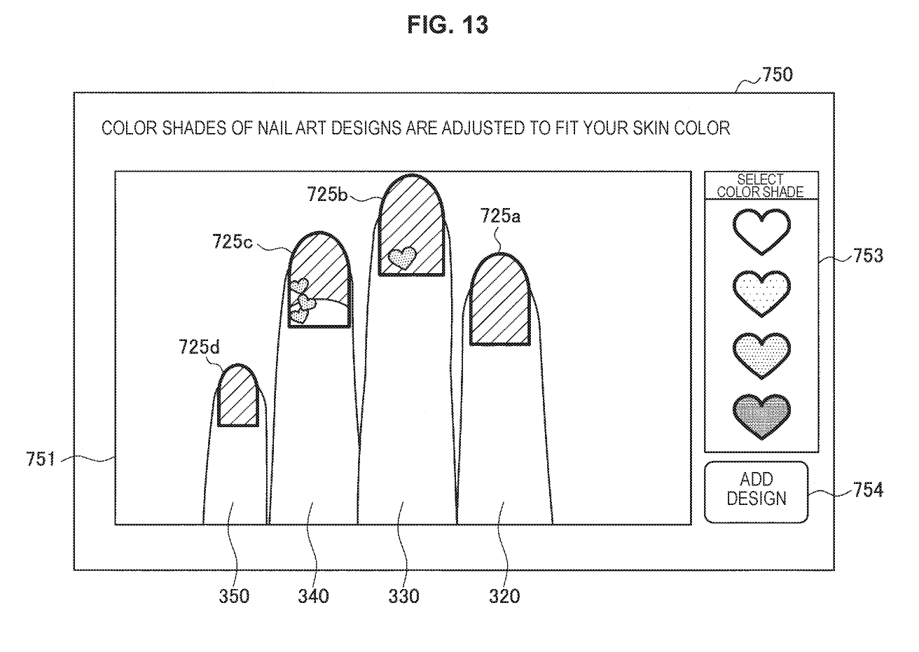

Next, the adjustment unit 603 of the control unit 60 adjusts colors or color shades of the nail art design to be recommended to the user on the basis of the acquired information of the user, and the output control unit 604 causes the display unit 70 to display the adjusted nail art design (Step S209). For example, the control unit 60 refers to color coordinating information or the like and recommends colors and color shades suitable to the user, on the basis of the acquired skin color, the hair color, color of clothing, or the like of the user. For example, in the case where the user has a yellowish skin, the control unit 60 may recommend orangish colors rather than pinkish colors, or recommend an orangish punk color rather than hot pink color among pinkish colors. Here, FIG. 13 illustrates an example of a nail art design color shade adjustment screen according to the embodiment.

In the illustrated example, a captured image display screen 751, a color shade selection screen 753, and a design addition button 754 are displayed in a screen 750. The captured image display screen 751 displays nail art design images 725a, 725b, 725c, and 7225d that are superimposed on nails of respective fingers (index finger 320, middle finger 330, ring finger 340, and little finger 350) of the user. The nail art design images 725a, 725b, 725c, 7225d are nail art images to be recommended to the user, and color shades of the nail art design images 725a, 725b, 725c, 7225d are adjusted in accordance with the skin color of the user.

Next, in the case where the user has performed an operation to change content recommended by the system side (YES in Step S212), the control unit 60 adjusts the nail art design in response to the changing operation, and learns preference of the user (Step S215). Specifically, for example, the control unit 60 changes designs and color shades in response to a user operation and registers designs and color shades that the user likes in the case where the design changing button 764 is tapped and the design is changed as illustrated in FIG. 12, or in the case where another color shade is selected in the color shade selection screen 753 as illustrated in FIG. 13. In addition, in the case where a change is made, it is also possible for the control unit 60 to display a question to ask why the user wants to make such a change and learn details of his/her preference.

The details of the nail art design decision process according to the embodiment have been described above. Note that, among the respective steps illustrated in FIG. 11, Step S206 and Step S209 may be performed in reverse order. In other words, the control unit 60 may decide colors or color shades first, and then recommend the patterns.

### <3-3. Nail Art Creation Process>

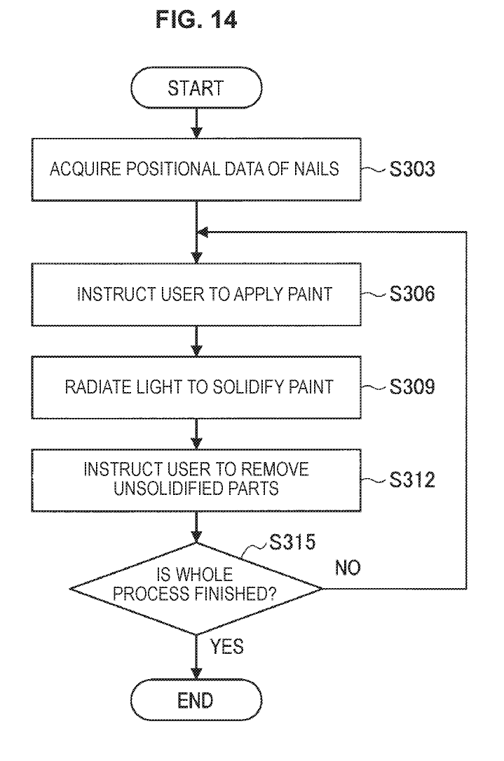

The details of the nail art design recommendation and the nail art design decision according to the embodiment have been described above. Next, with reference to FIG. 14, a nail art creation process will be described. In the nail art creation process, the decided nail art designs are created on nails.

FIG. 14 illustrates a flowchart of the nail art creation process according to the embodiment. As illustrated in FIG. 14, the control unit 60 first acquires positional data St and coordinate data Dt of nails of a hand of the user inserted into the insertion opening 110 of the nail art creation device 100 (Step S303).

Next, the control unit 60 instructs the user to apply paint to his/her nails (Step S306). The paint application instruction may be displayed on the display unit 70, or may be output by voice, for example. The paint to be applied is resin having high sensitivity to a 405 nm band.

Next, the control unit 60 transmits a control signal to the driving unit 50 (Step S309). The control signal instructs to radiate light to solidify the paint. The drive unit 50 radiates light with a sensitive wavelength range of resin A (405 nm hand) of resin A, to a target surface to which the resin A is applied. In this case, the laser light or LED light is radiated from the light source unit 10. In this way, it is possible to solidify the paint (in other words, it is possible to create the solidified resin part A).

Next, the control unit 60 instructs the user to remove unsolidified parts (Step S312). The removing instruction may be displayed on the display unit 70 or may be output by voice, for example.

Next, Step S306 to Step S312 are repeated until the whole process finishes (Step S315). In other words, the control unit 60 repeats Step S306 to Step S312 until optical products (here, nail art created on nails) are completed. For example, the control unit 60 instructs to apply resin B on surfaces including the solidified resin part, and radiates light with a sensitive wavelength range of the resin B (405 nm band) from the light source unit 10 to all over the resin B, to create a solidified resin part B. In this way, the optical products including the solidified resin part A and the solidified resin part B (such as nail art designs with two colors) are created on nails.

### <3-4. Complementary Nail Art Design Generation Process>

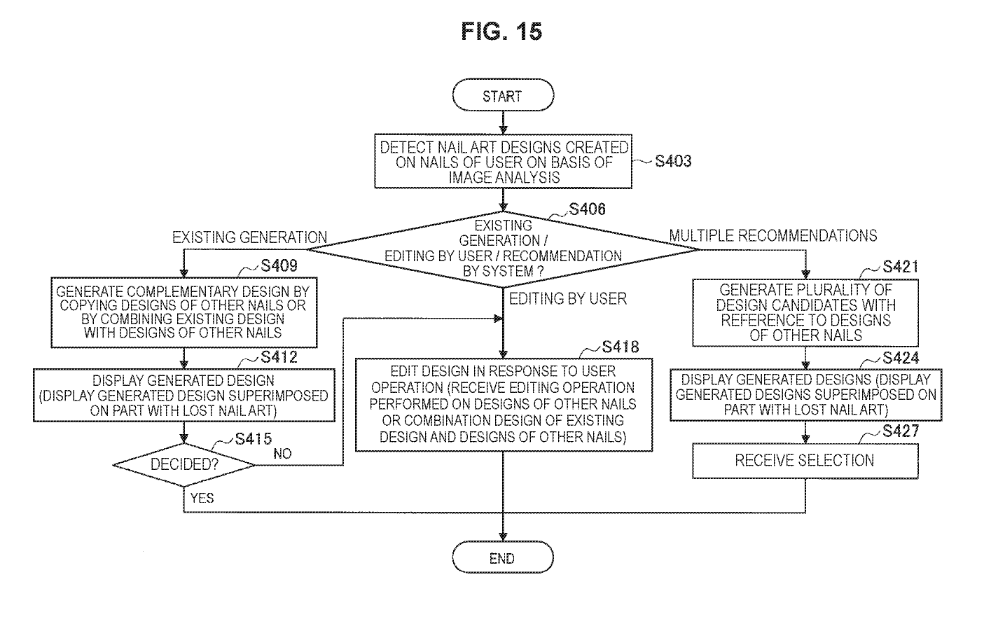

Next, with reference to FIG. 15, a complementary nail art design generation process will be described. For example, in the case where nail art of one of the nails has come off, it is possible to recommend a suitable nail art design with reference to nail art designs of the other fingers, and create nail art for the lost part. Next, detailed description is provided with reference to FIG. 15.

FIG. 15 is a flowchart illustrating the complementary nail art design generation process according to the embodiment. As illustrated in FIG. 15, first, the data acquisition unit 601 of the control unit 60 detects nail art designs created on the nails of the user, on the basis of an image analysis result of an image captured by the imaging unit 40 (Step S403).

Next, the nail art design decision unit 602 of the control unit 60 generates a complementary nail art design through any of “existing generation”, “editing by user”, and “recommendation by system” (Step S406). It is possible to preliminarily set which of the methods to be used, or it is also possible to cause the user to select any of the methods.

Next, in the case of the “existing generation”, the nail art design decision unit 602 generates a complementary nail art design that matches nail art designs of the other nails (nail art design having similar design concept) by copying the nail art designs of the other nails or by combining an existing nail art design with the nail art designs of the other nails (Step S409).

Next, the output control unit 604 of the control unit 60 performs control such that the generated nail art design is displayed on the display unit 70. In this case, it is possible for the output control unit 604 to display the generated nail art design superimposed on the part with lost nail art in the captured image (Step S412).

Subsequently, in the case where the user performs a deciding operation (YES in Step S415), the generation process finishes, and proceeds to a nail art creation process illustrated in FIG. 14.

On the other hand, in the case where a changing operation is performed by the user (NO in Step S415), or in the case of the “editing by user” (“EDITING BY USER” in Step S406), the adjustment unit 603 of the control unit 60 edits the nail art design in response to the operation performed by the user. For example, the adjustment unit 603 receives an editing operation performed on the nail art designs of the other nails or a combination design of an existing nail art design and the nail art designs of the other nails (Step S418).

Next, in the case of “multiple recommendations” (“MULTIPLE RECOMMENDATIONS” in Step S406), the nail art design decision unit 602 generates a plurality of design candidates with reference to designs of the other nails (Step S421).

Next, the display unit 70 displays the respective generated designs (Step S424).

Next, selection is received (Step S427).

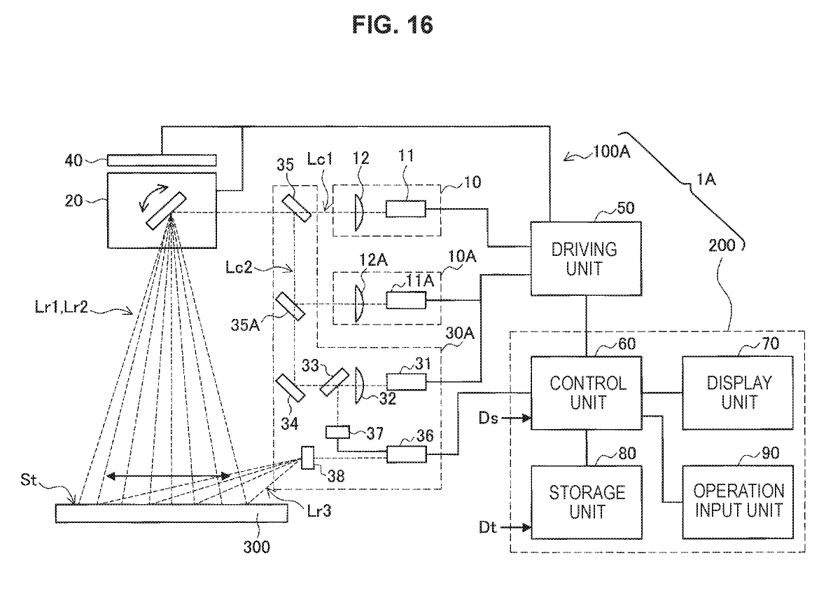

The details of the complementary: nail art design generation process according to the embodiment have been described above. Next, with reference to FIG. 16 to FIG. 19, modifications of the nail art creation system according to the embodiment will be described.

### <<4. Modifications>>

The configuration of the nail art creation system according to embodiment is not limited to the above described embodiment. For example, the nail art creation system may include an additional light source unit. Next, detailed description will be provided with reference to FIG. 16 to FIG. 19.

### <4-1. Modification A>

FIG. 16 is a diagram illustrating a configuration example of a nail art creation system 1A according to a modification A. As illustrated in FIG. 16, the nail art creation system 1A further includes a light source unit 10A capable of outputting a red light beam.

The light source unit 10A is capable of outputting collimated light on the basis of a driving signal from the drive unit 50. For example, the light source unit 10A includes a light emitting element 11A configured to output a red light beam, and a collimating lens 12A placed on an optical path of the red light beam. For example, the light emitting element 11A includes one or a plurality of semiconductor lasers, or one or a plurality of light emitting diodes. The light emitting element 11A is capable of outputting red light of a 650 nm band.

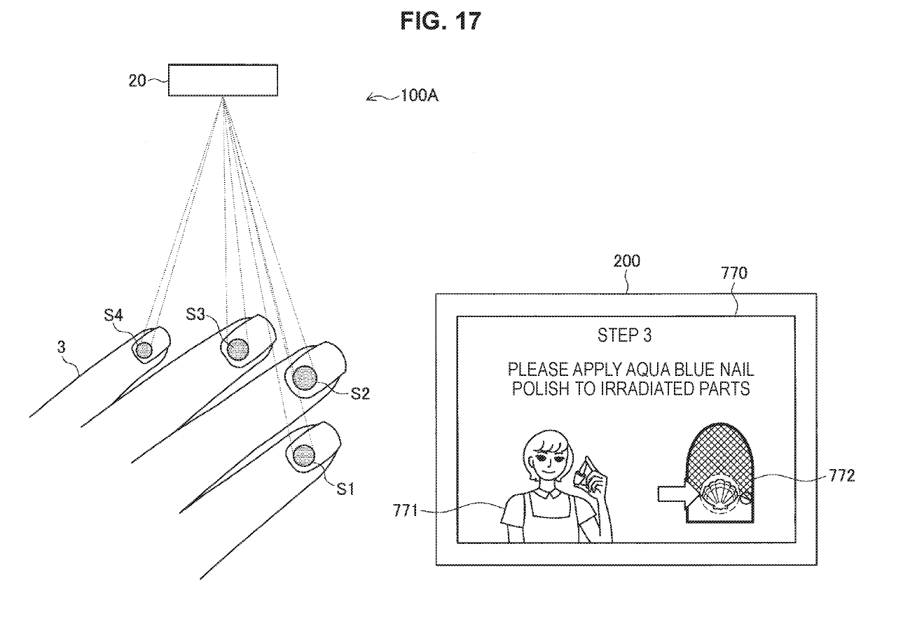

The red collimated light output from e light source unit 10A scans the target surface St via the movable mirror 20. In this way, it is possible to project nail art designs not on a screen but on actual fingers. The user can check positions and sizes of the nail art designs on the fingers. In addition, it is also possible for the display unit 70 to display an image of a state in which the red light is projected on the nails. The image is captured by the imaging unit 40. In addition, the red collimated light output from the light source unit 10A is used not only in the case of showing the positions and the sizes of the nail art designs to the user, but also in the case of showing a place to be covered by paint in the nail art creation process to the user. Next, how to use the application example A will be described with reference to FIG. 17.

As illustrated in FIG. 17, via the movable minor 20, light is radiated to a part to be covered with paint now on the nails of the hand 3. The user can watch irradiation regions S1 to S4 (in other words, guide marks) of the respective fingers and understand positions to which paint is to be applied. In this case, the display device 200 displays a screen 770 including an explanation such as “please apply aqua blue nail polish to the irradiated parts”, a character 771 who is a nail technician, and a nail art design image 772 that shows a part to be created in the next step, while explaining the next step.

### <4-2. Modification B>

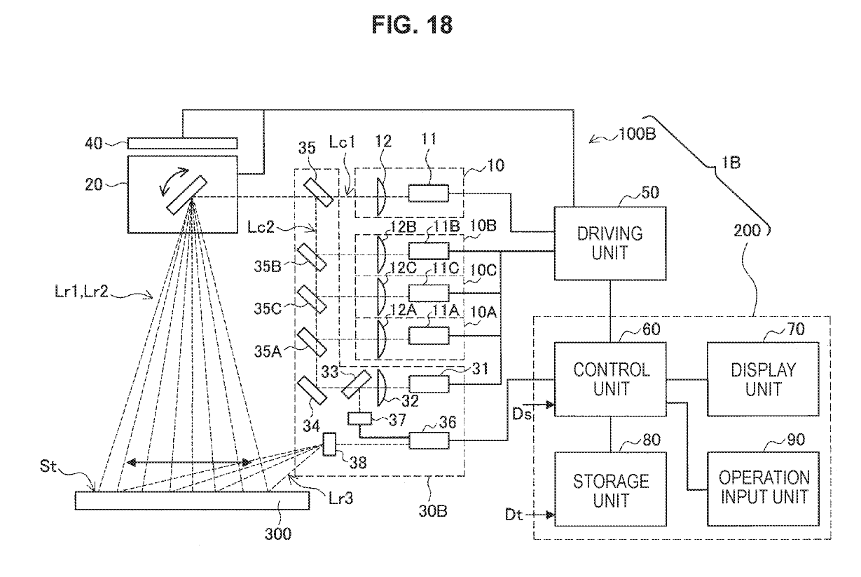

FIG. 18 is a diagram illustrating a configuration example of a nail art creation system 1B according to a modification B. As illustrated in FIG. 18, the nail art creation system 1B further includes a light source unit 10B capable of outputting a blue light beam, a light source unit 10C capable of outputting a green light beam, and the light source unit 10A capable of outputting a red light beam.

The light source unit 10B is capable of outputting collimated light on the basis of a driving signal from the drive unit 50. For example, the light source unit 10B includes a light emitting element 11B configured to output a blue light beam, and a collimating lens 12A placed on an optical path of the blue light beam. For example, the light emitting element 11B includes one or a plurality of semiconductor lasers, or one or a plurality of light emitting diodes. The light emitting element 11B is capable of outputting blue light of a 455 nm band.

The light source unit 10C is capable of outputting collimated light on the basis of a driving signal from the drive unit 50. For example, the light source unit 10C includes a light emitting element 11C configured to output a green light beam, and a collimating lens 12C placed on an optical path of the green light beam. For example, the light emitting element 11C includes one or a plurality of semiconductor lasers, or one or a plurality of light emitting diodes. The light emitting element 11C is capable of outputting green light of a 532 nm band.

In a way similar to the modification A, the light source unit 10A includes the light emitting element 11A and the collimating lens 12A. The light emitting element 11A is capable of outputting red light of the 650 nm band.

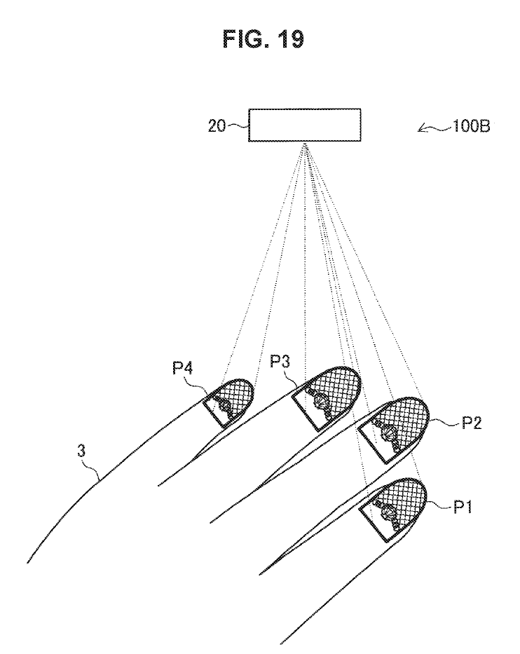

The red, blue, and green collimated light (RGB light) output from the light source units 10A, 10B, and 10C scans the target surface St via the movable mirror 20. In this way, it is possible to project nail art designs not on a screen but on actual fingers by using the RGB light of visible sensitive region, and this enables virtual trial fitting. Note that, it is also possible for the display unit 70 to display an image of a state in which the RGB light is projected on the nails. The image is captured by the imaging unit 40. Next, how to use the application example B will be described with reference to FIG. 19.

As illustrated in FIG. 19, via the movable mirror 20, nail art design images P1 to P4 are projected onto the respective nails of the hand 3. They are projected by using RGB light, and this allows the user to try on nail art in view of actual color shades.

### <4-3. Another Case>

In addition, according to the embodiment, it is also possible to detect states of fingers and nails of a user, compare them with general average values or previous data of the user, calculate dryness levels of the fingers and the nails of the user and thickness of the nails, and propose ways to care for them.

The control unit 60 quantifies surface states, shapes, and sizes of nails through image capturing, measurement of reflection of light radiated from a laser, or the like. Note that, it is possible to measure the thickness of nails not only from information of surfaces of the nails, but also from a captured image of nails from a lateral direction.

### <<5. Conclusion>>

As described above, by using the information processing system according to the embodiment of the present disclosure, it is possible to improve convenience of nail art creation systems and attach additional values to provision of nail art designs.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, it is also possible to create a computer program for causing hardware such as a CPU, ROM, and RAM, which are embedded in the above described nail art creation device 100 and display device 200, to execute the functions of the nail art creation device 100 and the display device 200. Moreover, it is possible to provide a computer-readable storage medium having the computer program stored therein.

Note that, the nail art creation device 100 according to the embodiment is configured to generate optical products by carrying out a scan with ultraviolet light from a laser or an LED as collimated light via a MEMS mirror or the like. However, the embodiment is not limited thereto. For example, it is possible to create optical products through projection. In the projection, a reflective projector is used. The reflective projector uses a digital mirror device (DMD) mirror such as Liquid crystal on silicon (LCOS), an MEMS mirror, or the like. In the case of the projection, it is necessary to adjust focus, in contrast to scanning.

In addition, the optical modeling device configured to utilize solidification of paint under laser light is used as an example of the nail art creation. However, the nail art creation device according to the embodiment is not limited thereto. It is also possible to use a device configured to create nail art on nails by applying paint through ink jet.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below
(1)

An information processing device including:

a decision unit configured to decide a nail art design to be recommended to a user in accordance with information obtained by sensing a finger of the user; and

an adjustment unit configured to adjust the decided nail art design.
(2)

The information processing device according to (1),

in which the adjustment unit adjusts a size of the nail art design in accordance with a size of a nail of the user.
(3)

The information processing device according to (1) or (2),

in which the adjustment unit adjusts a size of the nail art design and/or changes at least a part of the nail art design in response to user operation.
(4)

The information processing device according to any one of (1) to (3),

in which the nail art design includes at least any of a pattern and a color of nail art.
(5)

The information processing device according to (4),

in which the decision unit decides a color shade of a nail art design to be recommended to the user, in accordance with a skin color, a hair color, an eve color, or a color of clothing of the user.
(6)

The information processing device according to (4) or (5),

in which the decision unit decides at least any of a pattern and a color of the nail art in accordance with an age, a job, or a scene of the user.
(7)

The information processing device according to any one of (1) to (6), further including

an output control unit configured to output the decided nail art design or the adjusted nail art design to a display unit.
(8)

The information processing device according to (7),

in which the output control unit performs control such that an image in which the nail art design is superimposed on a nail of the user is output to the display unit.
(9)

The information processing device according to any one of (1) to (8), further including

a projector unit configured to project the decided nail art design or the adjusted nail art design onto a nail of the user.
(10)

The information processing device according to (7),

in which the output control unit performs control such that care information corresponding to a state of a nail of the user is output.
(11)

The information processing device according to any one of (1) to (10),

in which the decision unit generates a complementary nail art design to a part with a lost nail art design, on a basis of information of a nail art design obtained from a captured image of a nail of a user.
(12)

The information processing device according to any one of (1) to (11), further including

a nail art creation control unit configured to perform control such that the nail art design is created on a nail of the user.
(13)

The information processing device according to (12), further including

a radiation unit configured to radiate laser light with a wavelength that causes nail art paint applied to a nail to be solidified,

in which the nail art creation control unit controls optical scanning such that a position and a size of a nail are recognized, and the nail art design is created on the nail through light radiated by the radiation unit.
(14)

An information processing method including, by a processor:

deciding a nail art design to be recommended to a user in accordance with information obtained by sensing a finger of the user; and

adjusting the decided nail art design.
(15)

A program causing a computer to function as:

a decision unit configured to decide a nail art design to be recommended to a user in accordance with information obtained by sensing a finger of the user; and

an adjustment unit configured to adjust the decided nail art design.

### REFERENCE SIGNS LIST

1 nail art creation system

10 light source unit

11 light emitting element

12 collimating lens

20 movable mirror

30 sensor unit

31 light emitting element

32 collimating lens

33 half mirror

34 total reflection mirror

35 dichroic mirror

36 time lag detection circuit

37, 38 light receiving element

40 imaging unit

50 driving unit

60 control unit

70 display unit

80 storage unit

90 operation input unit

100 nail art creation device

110 insertion opening

200 display device

601 data acquisition unit

602 nail art design decision unit

603 adjustment unit

604 output control unit

1. An information processing device comprising:
a decision unit configured to decide a nail art design to be recommended to a user in accordance with information obtained by sensing a finger of the user; and
an adjustment unit configured to adjust the decided nail art design.

2. The information processing device according to claim 1,
wherein the adjustment unit adjusts a size of the nail art design in accordance with a size of a nail of the user.

3. The information processing device according to claim 1,
wherein the adjustment unit adjusts a size of the nail art design and/or changes at least a part of the nail art design in response to user operation.

4. The information processing device according to claim 1,
wherein the nail art design includes at least any of a pattern and a color of nail art.

5. The information processing device according to claim 4,
wherein the decision unit decides a color shade of a nail art design to be recommended to the user, in accordance with a skin color, a hair color, an eye color, or a color of clothing of the user.

6. The information processing device according to claim 4,
wherein the decision unit decides at least any of a pattern and a color of the nail art in accordance with an age, a job, or a scene of the user.

7. The information processing device according to claim 1, further comprising
an output control unit configured to output the decided nail art design or the adjusted nail art design to a display unit.

8. The information processing device according to claim 7,
wherein the output control unit performs control such that an image in which the nail art design is superimposed on a nail of the user is output to the display unit.

9. The information processing device according to claim 1, further comprising
a projector unit configured to project the decided nail art design or the adjusted nail art design onto a nail of the user.

10. The information processing device according to claim 7,
wherein the output control unit performs control such that care information corresponding to a state of a nail of the user is output.

11. The information processing device according to claim 1,
wherein the decision unit generates a complementary nail art design to a part with a lost nail art design, on a basis of information of a nail art design obtained from a captured image of a nail of a user.

12. The information processing device according to claim 1, further comprising
a nail art creation control unit configured to perform control such that the nail art design is created on a nail of the user.

13. The information processing device according to claim 12, further comprising
a radiation unit configured to radiate laser light with a wavelength that causes nail art paint applied to a nail to be solidified,
wherein the nail art creation control unit controls optical scanning such that a position and a size of a nail are recognized, and the nail art design is created on the nail through light radiated by the radiation unit.

14. An information processing method comprising, by a processor:
deciding a nail art design to be recommended to a user in accordance with information obtained by sensing a finger of the user; and
adjusting the decided nail art design.

15. A program causing a computer to function as:
a decision unit configured to decide a nail art design to be recommended to a user in accordance with information obtained by sensing a finger of the user; and
an adjustment unit configured to adjust the decided nail art design.
